(19) United States
(12) Patent Application Publication
(10) Pub. No.: US 2011/0041994 A1
(43) Pub. Date: Feb. 24, 2011

(54) Method and Apparatus for Encasing a Wooden Member

(76) Inventor: Randall Heath, Pinson, AL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/544,692

(22) Filed: Aug. 20, 2009

(51) Int. Cl. B32B 38/00

(52) U.S. Cl. 156/250; 156/425

(57) ABSTRACT

An apparatus for applying a vinyl cover to an elongated member utilizes a sheet extruder providing a sheet of pliable vinyl or fiber reinforced polymer of predetermined width, a feed conveyor capable of supporting and rotating an elongated member adjacent the sheet extruder such that a still hot and pliable sheet may be applied thereto beginning at a proximal end as the wooden member rotates. The feed conveyor includes a linear drive urging the member transversely of the sheet extruder to position the member for continuous application of the sheet substantially along the length thereof, a rotary drive engaging the member at the proximal end and capable of rotating the member to continuously apply the sheet over an opposite end of the member.

The present invention relates to structural members for docks, seawalls, walkways, decks and the like constructed in wetlands or adjacent a body of water where decay or deterioration of structures erected in such areas is accelerated by the prevalent moisture. More particularly, the present invention relates to wooden structural members for such environments wherein the wooden structural members are encased in a resin, vinyl, or plastic based coating.

### BACKGROUND

Plastic encasement of wooden or steel members is known as shown in U.S. Pat. Nos. 7,393,482 and 5,226,751 and 4,713,129, however, the known methods have not provided a reliable, economical, and durable structural member for use in the above environments. The present invention provides an economical reproducible structural member for use in the high moisture environment.

### SUMMARY OF THE INVENTION

The product forming the basis for this invention is a wooden structural member such as a beam, upright, piling or the like which has been encased in a waterproof plastic or vinyl outer layer. In accordance with the invention the structural member has been wrapped with an extruded sheet of plastic or FRP while the sheet is still hot from the extrusion process such that as the sheet spirals about the structural member it bonds to the structural member and itself at instances of overlap including along a spiral seam and at the ends of the structural member where excess sheet material is folded on itself to seal the ends.

To manufacture the product, we have designed an apparatus for applying a vinyl cover to an elongated wooden member such as a beam or post, comprising: a sheet extruder providing a sheet of pliable vinyl or fiber reinforced polymer of predetermined width, a feed conveyor capable of supporting and rotating a wooden member adjacent the sheet extruder such that a still hot and pliable sheet may be applied to the wooden member beginning at an end proximal the sheet extruder as the wooden member rotates. The feed conveyor includes a linear drive urging the wooden member supported thereby transversely of the sheet extruder to position the wooden member for continuous application of the sheet substantially along the length of the wooden member, an out feed conveyor engaging the wooden member at the proximal end and capable of rotating the wooden member to continuously apply the sheet over an opposite end of the wooden member such that the wooden member is completely encased by vinyl, and a magazine for supplying wooden members to the feed conveyor.

Using the above apparatus the invention provides a process for applying a vinyl cover to an elongated wooden member comprising the steps of: extruding a continuous sheet of vinyl having a predetermined width and thickness; rotatably supporting a wooden member in position to receive a leading end of the hot, pliable continuous sheet about a proximal end of the wooden member with a portion of the sheet extending beyond the proximal end; compressing the portion of the continuous sheet against a face of the wooden member on the proximal end thereof to cause the sheet to bond to itself; urging the wooden member transversely of the continuous sheet at a rate sufficient to wrap the sheet about the wooden member with the sheet overlapping itself along the length of the member and bonding to itself; severing the sheet member as a second end of the wooden member is wrapped within the sheet with a trailing portion extending beyond the second end; and, compressing the trailing portion against a second face of the wooden member on its second end thereof such that the sheet bonds to itself providing watertight encasement of the wooden member.

### BRIEF DESCRIPTION OF THE DRAWINGS

The product, its method of manufacture and the apparatus for manufacturing the product are illustrated in the accompanying drawings which form a portion of this disclosure and wherein:

FIG. 1 is a side elevational view of the product;

FIG. 2 is a sectional view transverse the long dimension of the product;

FIG. 3 is a simplified illustration of the apparatus; and

FIG. 4 is a flow chart of the process for making the product.

### DESCRIPTION OF THE PREFERRED EMBODIMENT

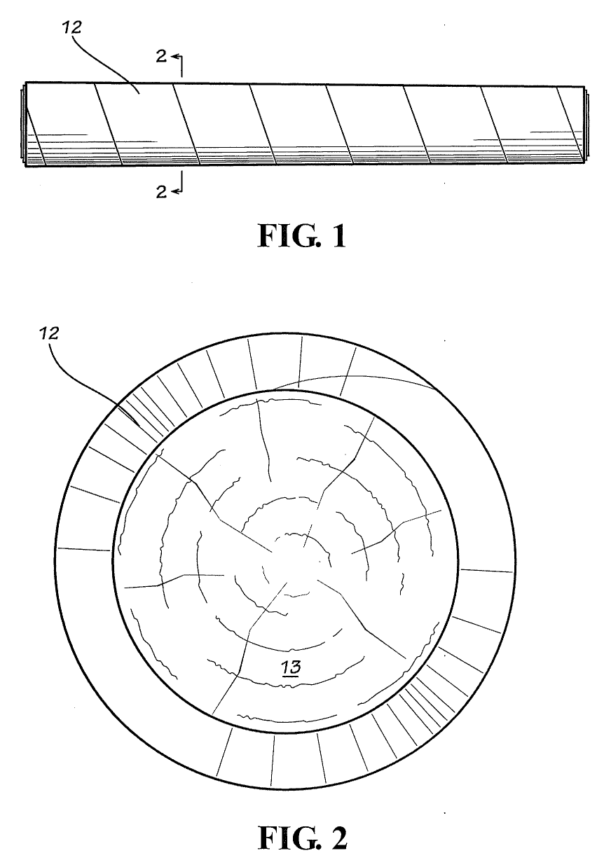

Referring to the figures for a clearer understanding of the invention it should be understood that FIGS. 1 and 2 are representative of any structural member, pile, waling, beam, support which may be made in accordance with the invention and therefore is intended to represent wooden members of a variety of sizes and configurations. Accordingly, some variations from rectilinear or cylindrical configurations are expected and encompassed within the scope of the invention.

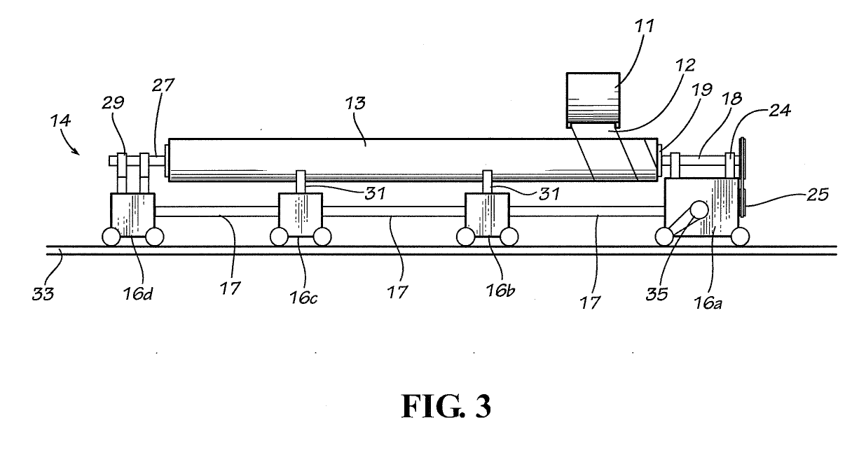

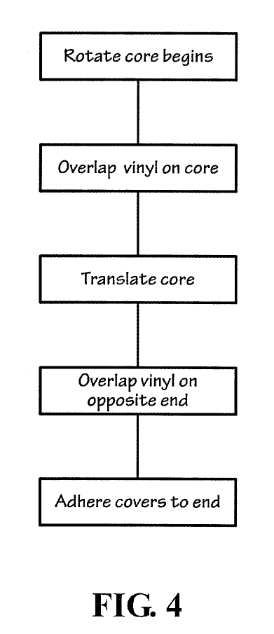

Referring to FIG. 3, it will be seen that a sheet extruder 11 is positioned to discharge a continuous sheet 12 along a substantially horizontal plane, noting that the orientation of the sheet is critical only relative to the position of a wooden member 13 to be encased by the sheet. The sheet material may be selected from any acceptable extrudable resin, either virgin, reprocessed, reinforced, or recycled. The material may have selected additives to prolong product life, impart coloring, strength or adhesion. Extending parallel to the sheet 12 and in a direction transverse to the discharge direction of the sheet is a feed conveyor 14 which may be a carriage or dolly mounted for linear reciprocal movement on a track or rail to one side of the extruder 11. As may be seen in FIG. 3, the conveyor 14 can encompass a plurality of movable carriages 16 connected by an adjustable linkage 17 that allows carriages 16 to be spaced appropriately for the item being encased. At one end of wooden member 13 a spindle 18 is supported on carriage 16a. Spindle 18 terminates in a hub 19 which may include eyelets 21 to allow the insertion there through of screws 23 which can be used to secure the spindle 18 to the end of the wooden member 13. Spindle 18 is mounted for rotation about its longitudinal axis in journal blocks 24 and is driven by a motor 25, which may be hydraulic, pneumatic or electrical in nature. At the opposite end of wooden member 13 carriage 16d carries a spindle 27, mounted for free rotation in a set of journal blocks 29, which also terminates in a hub which is used to attaché spindle 27 to the end of wooden member 13. Intermediate carriages 16a and 16d are one or more support carriages 16c and 16b which each support a set of rollers 31 on which wooden member 13 is partially supported. The rollers may be biased, pneumatically or by springs, for necessary movement as the wooden member is rotated to maintain appropriate contact with the surface of the wooden member which may be somewhat uneven.

Carriages 16a-16d are moved along rail or track 33 which runs adjacent extruder 11 by a mover 35 which allows wooden member to be advanced a controlled even rate, thus a fluid driven motor, an electric motor, a linear actuator with appropriate limit switches and controls, or any conventional controllable drive may be used to urge the carriages and wooden member along track 33. Preferably, the drive is be reversible such that carriages 16a-d can be returned to their starting location.

In operation wooden member 13 is secured between spindles 18 and 27 in any suitable manner and supported on rollers 31. It will be appreciated that the surface of the wooden member may need to be prepared such as by sanding or shaving to remove any severe discontinuities which might penetrate the vinyl coating during the encasement process. Motor 25 is engaged to rotate wooden member 13 and extruder 11 is engaged to extrude a sheet of vinyl. The leading edge of the extruded vinyl sheet 12 is carried over the leading end of wooden member 13 by an operator or by a puller mechanism, such as a gripper mounted for outward and downward movement relative to extruder 11, such that the lateral 36 margin of sheet 12 extends beyond the leading end. As sheet 12 is extruded wooden member 13 is rotated by motor 25 until the leading end of wooden member 13 is completely encircled by sheet 12 with a portion of sheet 13 extending beyond the end. Mover 35 is then actuated to urge wooden member 13 along track 33 such that sheet 12 wraps about wooden member 13 as an overlapping spiral, thereby adhering to wooden member 13 and to itself to form a substantially water tight elongated casing about wooden member 13. Sheet 12 is wrapped about the trailing end of wooden member 13 as carriage 14 moves the member past the extruder and then severed such that the free end of sheet 12 may be folded over the trailing end of member 13. Spindles 18 and 27 may then be disengaged and an end sheet of vinyl may be applied to the ends of the wooden member to complete the sealing of the casing about the wooden member. The application may be made by manually heating a circular sheet of vinyl until it softens sufficiently to adhere to the portion of sheet 12 already applied to the ends and to the end of the wooden member. Alternatively the end covers may be applied with heated mechanical paddles in an automated manner.

It is to be understood that the term wooden members means any elongated wooden member, whether made from solid wood or some other composite such as pressed wood or laminate. Further, it is contemplated that the present invention may be utilized to encase other structural members made from core material other than wood, such as metal, foam or other composites. It is also contemplated that the vinyl sheet may comprise any suitable vinyl polymer or fiber reinforced polymer having suitable physical characteristics to prevent corrosion or rotting of the core material when the spiral encasement is completed. It is further to be understood that the specific embodiments described herein are not intended as limitations on the invention which is entitled to the full scope of the appended claims.

What I claim is:

1. An apparatus for applying a vinyl cover to an elongated core member such as a beam or post, comprising: a sheet extruder providing a sheet of pliable vinyl of predetermined width, a feed conveyor capable of supporting and rotating said core member adjacent said sheet extruder such that said sheet may be applied to said core member beginning at an end proximal said sheet extruder as said core member rotates, said feed conveyor including a longitudinal drive urging said core member supported thereby transversely of said sheet extruder to position said core member for continuous application of said sheet substantially along the length of said core member.

2. Apparatus as defined in claim 1, wherein said feed conveyor further comprises a rotational drive engaging said core member and capable of rotating said core member to continuously apply said sheet over an opposite end of said core member as said longitudinal drive urges said core member past said extruder.

3. Apparatus as defined in claim 2, further comprising a folding arm mounted for reciprocal movement normal to said proximal end to urge excess sheet material extending beyond said proximal end against a face of said core member on said proximal end.

4. Apparatus as defined in claim 4, further comprising a folding arm mounted for reciprocal movement normal to said opposite end to urge excess sheet material extending beyond said opposite end against a face of said core member on said opposite end.

5. A process for applying a vinyl cover to an elongated core member comprising the steps of:
a. extruding a continuous sheet of vinyl having a predetermined width and thickness;
b. rotatably supporting a core member in position to receive a leading end of said continuous sheet about a proximal end of said core member with a portion of said sheet extending beyond said proximal end;
c. compressing said portion of said continuous sheet against a face of said core member on said proximal end thereof;
d. urging said core member transversely of said continuous sheet at a rate sufficient to wrap said sheet about said core member with said sheet overlapping itself along the length of said member;
e. severing said sheet member as a second end of said core member is wrapped within said sheet with a trailing portion extending beyond said second end; and,
f. compressing said trailing portion against a second face of said core member on its second end thereof.

6. The process as defined in claim 5, wherein said compressing step and said urging step are substantially concomitant.

7. The process as defined in claim 6, including the step of optionally adhering a disc of vinyl to the portion of said sheet of vinyl compressed against a face of said core member by heating said vinyl and urging said disc against said face.

8. A process as defined in claim 7, further comprising, feeding a plurality of core members from a supply thereof into position to be sequentially rotably supported to receive a leading end of said continuous sheet; and, repeating steps 6 a to 6f for each core member.
